(19) United States
(12) Patent Application Publication
(10) Pub. No.: US 2008/0278541 A1
(43) Pub. Date: Nov. 13, 2008

(54) LIQUID EJECTING HEAD UNIT AND LIQUID EJECTING APPARATUS

(75) Inventors: Hiroshige OWAKI, Okaya-shi (JP); Yuichi WATANABE, Matsumoto-shi (JP); Kazutoshi GOTO, Matsumoto-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: Seiko Epson Corporation, Tokyo (JP)

(21) Appl. No.: 12/118,293

(22) Filed: May 9, 2008

(30) Foreign Application Priority Data
May 10, 2007 (JP) 2007-125460

(51) Int. Cl. B41J 2/135

(52) U.S. Cl. 347/45

(57) ABSTRACT

The invention provides a liquid ejecting head unit that includes: a liquid ejecting head that has pressure generation chambers and pressure generators, the pressure generation chambers being in communication with nozzle openings from which liquid is ejected, the pressure generator causing a pressure change in the pressure generation chamber; a fixing member that is adhered to the liquid ejecting surface of the liquid ejecting head, the liquid ejecting surface having the nozzle openings formed therein, the fixing member having an exposure opening portion that exposes the nozzle openings; and a recording portion that has convexity and concavity so as to record head information, the recording portion being provided at a region of the liquid ejecting surface at which the fixing member is adhered.

### CROSS-REFERENCE TO RELATED APPLICATIONS

This application claims convention priority under 35 U.S.C. 119 to obtain the benefit of the earlier filing date, May 10, 2007, of Japanese Patent Application No. 2007-125460. The contents of the above-identified Japanese Patent Application including the specification, drawings, and abstract are incorporated herein by reference in their entirety.

### BACKGROUND

1. Technical Field

The present invention relates to a liquid ejecting head unit and a liquid ejecting apparatus.

2. Related Art

When a plurality of ink-jet recording heads is assembled together so as to manufacture an ink-jet recording head unit, it is necessary to choose an appropriate set of the ink-jet recording heads so that these ink-jet recording heads that makes up one ink-jet recording head unit have uniform ink-discharging characteristics (liquid ejecting characteristics) among them. In order to achieve such uniformity in the ink-discharging characteristics of these ink-jet recording heads, in the technical field to which the present invention pertains, a method for embedding (i.e., recording) head information in the form of a convex and concave pattern in the liquid ejecting surface of an ink-jet recording head where nozzle holes are formed has been proposed so far.

The proposed solution of the related art in which, as described above, head information is recorded as convexity and concavity formed in the liquid ejecting surface in which nozzle holes are bored (hereafter referred to as “head-information-recording portion”) has a problem in that ink could remain on the head-information-recording portion without being wiped (i.e., cleaned) therefrom even after the cleaning (i.e., wiping) of the liquid ejecting surface performed by means of a wiping unit such as a wiping blade, though not limited thereto. In such a case, the remaining ink could make it harder or impossible to read the head information out of the head-information-recording portion. In addition, the ink that remains on the head-information-recording portion without being wiped therefrom could become thickened thereon. In such a case, the thickened ink could adhere to the nozzle holes at the time of the execution of wiping so as to cause the clogging thereof and/or the degradation of ink discharging characteristics thereof. Moreover, if the head-information-recording portion having a convex and concave pattern is formed in the liquid ejecting surface, which is wiped by means of a wiping blade or the like, the wiping blade could become in contact with the head-information-recording portion during its operation so as to be damaged by the head-information-recording portion unless any appropriate technical solution is provided to such a problem. If this occurs, the cleaning capability of the wiping unit will be lowered.

In an effort to provide a technical solution to the above-identified problem, JP-A-2005-319645 (specifically, refer to Page 8 as well as FIGS. 2 and 6 thereof) discloses an ink-jet recording head of the related art. The related-art ink-jet recording head described in JP-A-2005-319645 is configured as follows. An information-recording portion that is embodied as a two-dimensional code such as a QR code (registered trademark), a barcode, or the like, is formed in a spacer by means of a laser-machining technique/method. The spacer is adhered onto the nozzle-plate-side surface of a fluid channel formation substrate (i.e., flow channel formation substrate). A transparent nozzle plate is adhered onto the spacer. Having such a configuration, the related-art ink-jet recording head described in JP-A-2005-319645 makes it possible to read information out of the information-recording portion from the outside thereof while preventing the information-recording portion from being stained by ink.

Disadvantageously, the related-art configuration of the ink-jet recording head according to JP-A-2005-319645 explained above essentially means that it has two sheets of nozzle plates, which inevitably increases production cost due to increased number of components.

In addition to the above-described problem, the related-art configuration of the ink-jet recording head according to JP-A-2005-319645 explained above requires a relatively long distance from the pressure generation chamber to the ink-discharging-surface-side open end of the nozzle hole, thereby making it practically impossible or at best difficult to obtain good liquid-ejecting characteristics. Furthermore, if the thickness of the nozzle plate is reduced in the related-art configuration of the ink-jet recording head according to JP-A-2005-319645 explained above for the purpose of obtaining better liquid-ejecting characteristics, it becomes harder to form the head-information-recording portion in the nozzle plate and also makes harder to handle the nozzle plate because of a resultant decrease in the rigidity of component members that make up the nozzle plate. Moreover, in the related-art configuration of the ink-jet recording head according to JP-A-2005-319645 explained above, it is necessary to record head information in the information-recording portion during the production of an ink-jet recording head. This means that it is not possible to record, in the information-recording portion, information on the finished-product characteristics of the ink-jet recording head after the completion of the production thereof.

The above-identified problems are not unique to an ink-jet recording head unit that has ink-jet recording heads. That is, the above-identified problems could also occur in a variety of liquid ejecting head units that has liquid ejecting heads for ejecting various kinds of liquid including ink but not limited thereto.

### SUMMARY

An advantage of some aspects of the invention is to provide a liquid ejecting head unit that offers excellent liquid ejecting characteristics while effectively preventing the nozzle openings thereof from becoming clogged.

As a fundamental aspect thereof: the invention provides a liquid ejecting head having a novel and inventive configuration defined as follows. A liquid ejecting head unit that includes: a liquid ejecting head that has pressure generation chambers and pressure generators, the pressure generation chambers being in communication with nozzle openings from which liquid is ejected, the pressure generator causing a pressure change in the pressure generation chamber; a fixing member that is adhered to the liquid ejecting surface of the liquid ejecting head, the liquid ejecting surface having the nozzle openings formed therein, the fixing member having an exposure opening portion that exposes the nozzle openings; and a recording portion that has convexity and concavity so as to record head information, the recording portion being provided at a region of the liquid ejecting surface at which the fixing member is adhered.

Other features and advantages offered by the invention will be fully understood by referring to the following detailed description in conjunction with the accompanied drawings.

In order to address the above-identified problems without any limitation thereto, the invention provides, as a first aspect thereof, a liquid ejecting head unit that includes: a liquid ejecting head that has pressure generation chambers and pressure generators, the pressure generation chambers being in communication with nozzle openings from which liquid is ejected, the pressure generator causing a pressure change in the pressure generation chamber; a fixing member that is adhered to the liquid ejecting surface of the liquid ejecting head, the liquid ejecting surface having the nozzle openings formed therein, the fixing member having an exposure opening portion that exposes the nozzle openings; and a recording portion that has convexity and concavity so as to record head information, the recording portion being provided at a region of the liquid ejecting surface at which the fixing member is adhered.

With such a configuration, since the fixing member covers the recording portion formed in the liquid ejecting surface, it is possible to prevent liquid from remaining on the recording portion without being wiped therefrom even after the cleaning of the liquid ejecting surface performed by means of a wiping unit such as a wiping blade, though not limited thereto. Moreover, since the fixing member covers the recording portion formed in the liquid ejecting surface, it is possible to prevent liquid that remains on the recording portion without being wiped therefrom even after the cleaning of the liquid ejecting surface performed by means of the wiping unit from becoming thickened thereon, thereby making it further possible to prevent such thickened liquid from adhering to the nozzle openings at the time of the execution of wiping so as to cause the clogging thereof and/or the degradation of liquid discharging characteristics thereof. Furthermore, since the fixing member covers the recording portion formed in the liquid ejecting surface, it is possible to prevent the aforementioned wiping unit such as a wiping blade, though not limited thereto, from becoming in contact with the recording portion during its operation so as to be damaged by the recording portion. Therefore, it is possible to prevent the cleaning capability of the wiping unit from becoming lowered. Still furthermore, since the fixing member covers the recording portion formed in the liquid ejecting surface, it is possible to achieve a lower cost without increasing the number of component members that make up the liquid ejecting head unit. Still furthermore, since the fixing member covers the recording portion formed in the liquid ejecting surface, it is possible to achieve a relatively short distance from the pressure generation chamber to the liquid-ejecting-surface-side open end of the nozzle opening, thereby making it further possible to obtain excellent liquid-ejecting characteristics. Still furthermore, since the recording portion is formed in the liquid ejecting surface, it is possible to record, in the recording portion, information on the finished-product characteristics of the liquid ejecting head after the completion of the production thereof.

In the configuration of the liquid ejecting head unit according to the first aspect of the invention described above, it is preferable that a liquid-repellent film should be formed on the liquid ejecting surface; and the region of the liquid ejecting surface at which the fixing member is adhered should be a non-liquid-repellent region at which the liquid-repellent film is not formed. With such a preferred configuration, it is possible to increase a bonding strength between the fixing member and the liquid ejecting surface.

In the configuration of the liquid ejecting head unit according to the first aspect of the invention described above, it is preferable that the liquid ejecting head should further have a fluid channel formation substrate in which the pressure generation chambers are formed and a nozzle plate through which the nozzle openings are formed; and the fluid channel formation substrate should have a concave portion at a region that faces the recording portion. With such a preferred configuration, the presence of the concave portion makes it possible to prevent the formation of any gap between the nozzle plate and the fluid channel formation substrate even in a case where the deformation of the nozzle plate occurs at the time of the formation of the recording portion by means of a laser-machining technique/method or other alternative methods. In addition thereto, the presence of the concave portion makes it possible to prevent the fluid channel formation substrate from being damaged even in a case where the deformation of the nozzle plate occurs at the time of the formation of the recording portion by means of a laser-machining technique/method or other alternative methods.

In the configuration of the liquid ejecting head unit according to the first aspect of the invention described above, it is preferable that a plurality of liquid ejecting heads should be adhered to the fixing member. With such a preferred configuration, it is possible to acquire head information from the recording portion of each liquid ejecting head and then to choose an appropriate set of liquid ejecting heads that have uniform liquid ejecting characteristics among them on the basis of the acquired head information. Then, these liquid ejecting heads having the same liquid ejecting characteristics are assembled together to make up a liquid ejecting head unit. By this means, it is possible to enhance printing quality/characteristics thereof. Furthermore, since the liquid ejecting surfaces of the plurality of liquid ejecting heads are adhered to the fixing member, it is possible to make the level of the liquid ejecting surfaces of these liquid ejecting heads equal to one another. By this means, it is possible to achieve uniformity in the liquid ejecting characteristics of the liquid ejecting heads.

In the configuration of the liquid ejecting head unit according to the first aspect of the invention described above, it is preferable that a cover head should be provided at one-face side of the fixing member opposite the other-face side thereof, the other face of the fixing member being adhered to the liquid ejecting surface of the liquid ejecting head; and the cover head should cover the liquid ejecting surface of the liquid ejecting head. With such a preferred configuration, it is possible not only to protect the liquid ejecting surface by means of the cover head but also to prevent the infiltration of liquid over/into the side surfaces of the liquid ejecting head.

In the preferred configuration described above, it is further preferable that the cover head should be adhered to the above-mentioned one face of the fixing member opposite the above-mentioned other face thereof that is adhered to the liquid ejecting surface of the liquid ejecting head. With such a preferred configuration, it is possible to make the difference in level between the cover head and the fixing member relatively small. Thanks to such a smooth structure, it is further possible to prevent any liquid from undesirably remaining on the liquid-drop discharging surface thereof after wiping operation, suction operation, or the like, has been performed thereon.

In order to address the above-identified problems without any limitation thereto, the invention provides, as a second aspect thereof, a liquid ejecting apparatus that is provided with the liquid ejecting head unit according to the first aspect of the invention described above.

### BRIEF DESCRIPTION OF THE DRAWINGS

The invention will be described with reference to the accompanying drawings, wherein like numbers reference like elements.

FIG. 1 is a diagram that schematically illustrates an example of the configuration of an ink-jet recording apparatus, which is a non-limiting example of various kinds of liquid ejecting apparatuses according to a first exemplary embodiment of the invention.

FIG. 2 is an exploded perspective view that schematically illustrates the exemplary configuration of an ink-jet recording head unit, which is illustrated herein as an example of a liquid ejecting head unit according to the first embodiment of the invention.

FIG. 3 is an assembled perspective view of the ink-jet recording head unit according to the first embodiment of the invention.

FIG. 4 is a sectional view of the ink-jet recording head unit according to the first embodiment of the invention that schematically illustrates the essential components thereof.

FIG. 5 is an exploded perspective view that schematically illustrates an example of the configuration of a recording head according to the first embodiment of the invention.

FIG. 6 is a plan view that schematically illustrates an example of the liquid-ejecting surface of the recording head according to the first embodiment of the invention.

FIG. 7A is a sectional view taken along the line VIIA-VIIA of FIG. 6, whereas FIG. 7B is a sectional view taken along the line VIIB-VIIB of FIG. 6.

### DESCRIPTION OF EXEMPLARY EMBODIMENTS

With reference to the accompanying drawings, preferred embodiments of the invention are explained below. Although the invention is described below while explaining exemplary embodiments thereof, the specific embodiments described below are not intended to limit the scope of the invention recited in the appended claims and thus should be in no case understood to restrict thereof; nor is it always necessary to encompass all of features and/or a combination(s) thereof that are described in the following embodiments as means for solving the problem identified by the invention and/or as means for achieving advantageous effects offered by the invention.

### Embodiment 1

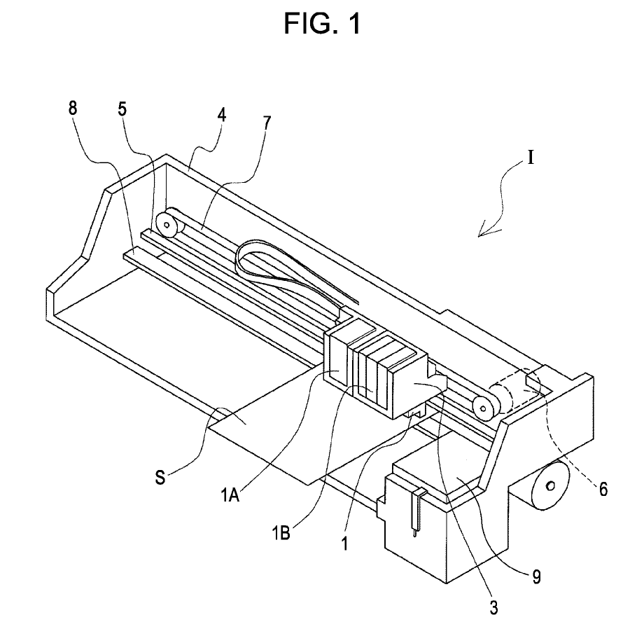

FIG. 1 is a diagram that schematically illustrates an example of the configuration of an ink-jet recording apparatus, which is a non-limiting example of various kinds of liquid ejecting apparatuses according to a first exemplary embodiment of the invention. As illustrated in FIG. 1, an ink-jet recording apparatus I (which is a non-limiting example of various kinds of liquid ejecting apparatuses as explained above) is provided with an ink-jet recording head unit 1. As its name indicates, the ink-jet recording head unit 1 has an ink-jet recording head. The ink-jet recording head is a non-limiting example of various kinds of liquid ejecting heads according to the first exemplary embodiment of the invention. Ink cartridges 1A and 1B, which constitute ink supply units, are detachably attached to the ink-jet recording head unit 1. In the following description, the ink-jet recording head unit 1 may be simply referred to as “head unit” 1. The head unit (ink-jet recording head unit) 1 to which the ink cartridges 1A and 1B are detachably attached is mounted on a carriage 3.

The carriage 3 on which the head unit 1 is mounted is configured to move freely in the axial direction of a carriage axis 5, which is fixed to an apparatus body chassis 4. The head unit 1 is configured to discharge, for example, black ink compound and color ink compound, which are retained in the ink cartridges 1A and 1B, respectively.

As the driving force of a driving motor 6 is communicated/transmitted to the carriage 3 by means of a plurality of gears that are not shown in the drawing and a timing belt 7, the carriage 3 on which the head unit 1 is mounted travels (i.e., moves) along the carriage axis 5. A platen 8 is provided in the apparatus body chassis 4 along the carriage axis 5. A recording sheet S, which is a recording target medium (i.e., print target medium) such as a sheet of paper that is supplied by a paper-feed roller or the like, is transported on the platen 8. Note that the paper-feed roller is not shown in the drawing.

A wiping unit 9, which is a blade made of an elastic member or the like, is provided in the ink-jet recording apparatus I. A non-limiting example of the material of the elastic member is rubber. The wiping unit 9 is provided parallel to the platen 8. The wiping unit 9 is used for cleaning (i.e., wiping) the liquid-ejecting surface of the head unit 1. The wiping unit 9 cleans the liquid-ejecting surface of the head unit 1 from/through which liquid (e.g., ink) is ejected. By this means, it is possible to wipe out any unwanted liquid (e.g., residue ink) that remains on the liquid-ejecting surface thereof.

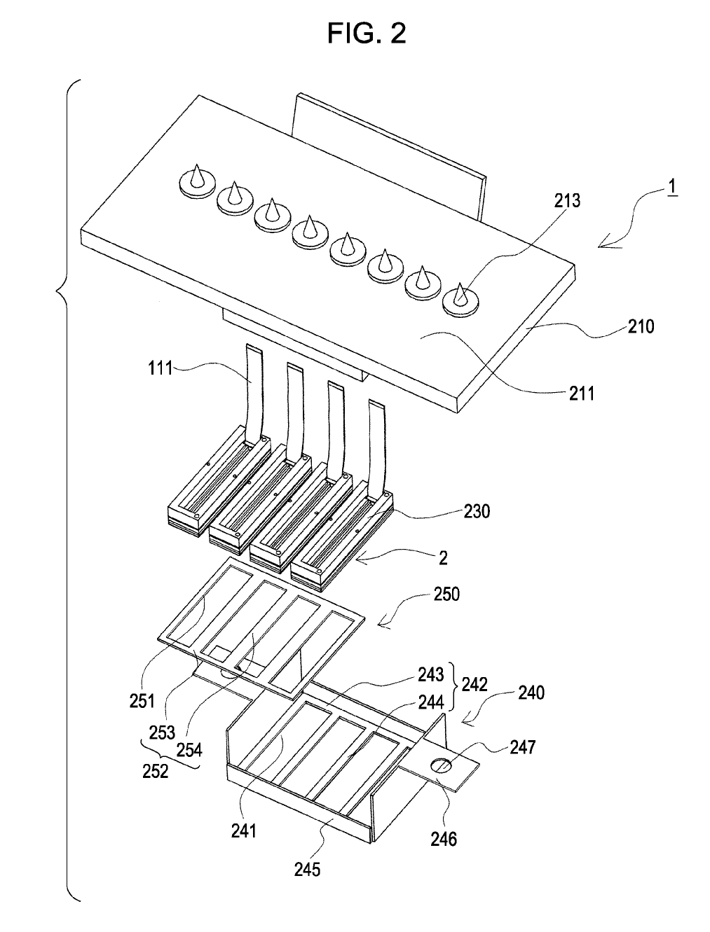

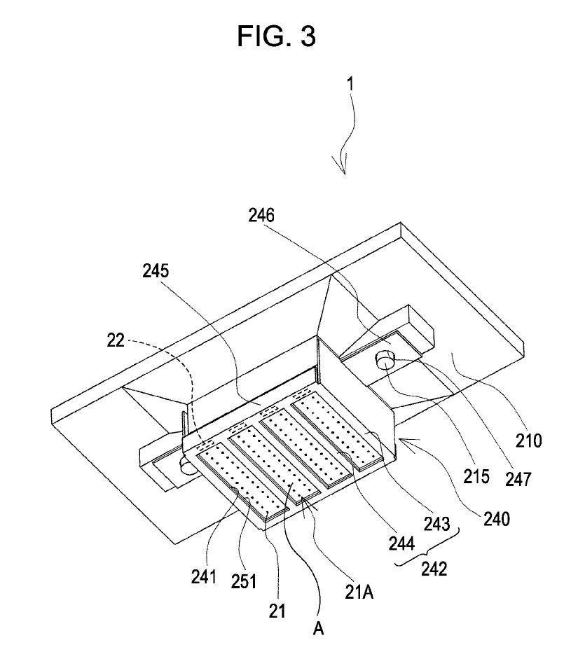

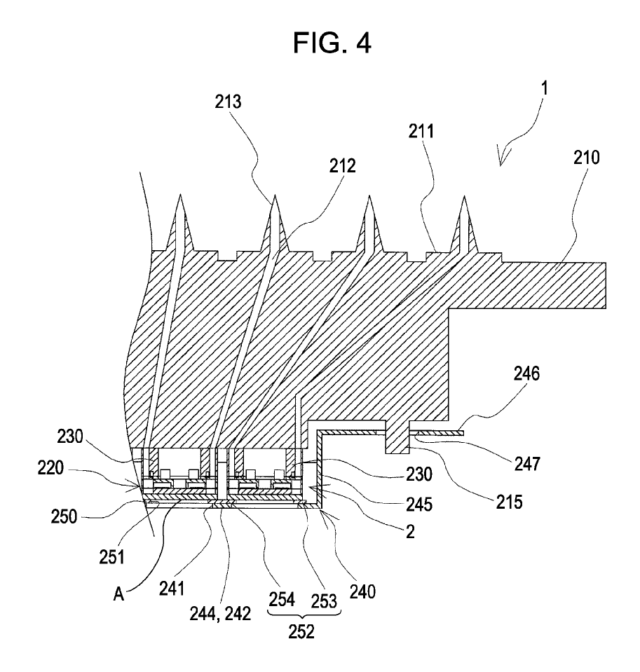

In the following description, a detailed explanation is given of the configuration of the ink-jet recording head unit 1 that is a non-limiting example of various kinds of liquid ejecting head units according to the first exemplary embodiment of the invention. FIG. 2 is an exploded perspective view that schematically illustrates the exemplary configuration of the ink-jet recording head unit 1, which is illustrated herein as an example of a liquid ejecting head unit according to the first embodiment of the invention. FIG. 3 is an assembled perspective view of the ink-jet recording head unit 1 illustrated in FIG. 2. FIG. 4 is a sectional view of the ink-jet recording head unit 1 that schematically illustrates the essential components thereof.

As illustrated in FIG. 2, a cartridge case 210, which is a supporting member that constitutes a part of the head unit 1, has a cartridge attachment unit 211 to which each of the ink cartridges 1A and 1B (refer to FIG. 1) is detachably attached. The ink cartridges 1A and 1B function as ink-supply units. In the present embodiment of the invention, each of the ink cartridges 1A and 1B is configured as an independent unit (i.e., separate unit). Black ink and three color inks are filled and retained in these ink cartridges 1A and 1B, respectively. Each of these ink cartridges 1A and 1B is attached to the cartridge case 210. As illustrated in FIG. 4, a plurality of ink communicating passages 212 is provided in the bottom portion of the cartridge case 210. Specifically, one end of each of the plurality of ink communicating passages 212 opens at the cartridge-attachment-unit (211) side of the cartridge case 210, whereas the other end thereof opens at the head-case side thereof. An explanation on the head case will be given later. At each open end of the ink communicating passages 212 at the cartridge-attachment-unit (211) side of the cartridge case 210, an ink supply needle 213 is provided. The ink supply needle 213 is to be inserted through the ink supply port of an ink cartridge. Each of the ink supply needles 213 is fixedly mounted thereat with a filter being interposed therebetween. The filter, which is not shown in the drawing, is provided in the ink communicating passage 212 in order to catch any air bubble and/or foreign object that are present in ink.

Each of a plurality of ink-jet recording heads 2 is fixedly mounted at the bottom-surface side of the cartridge case 210 with the aforementioned head case 230 being interposed therebetween.

The plurality of the ink-jet recording heads 2 correspond to respective ink colors so that each of the ink-jet recording heads 2 discharges ink of a corresponding color retained in the ink cartridge 1A, 1B (refer to FIG. 1). In the configuration of the ink-jet recording apparatus I according to the present embodiment of the invention, four ink-jet recording heads 2 are provided for one head unit 1.

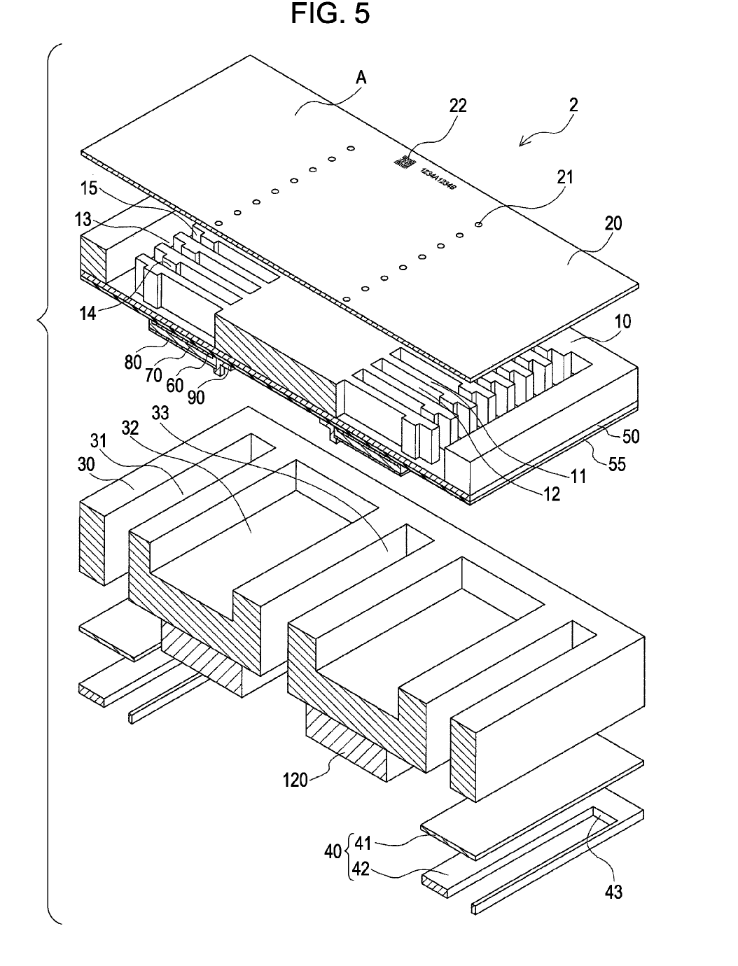

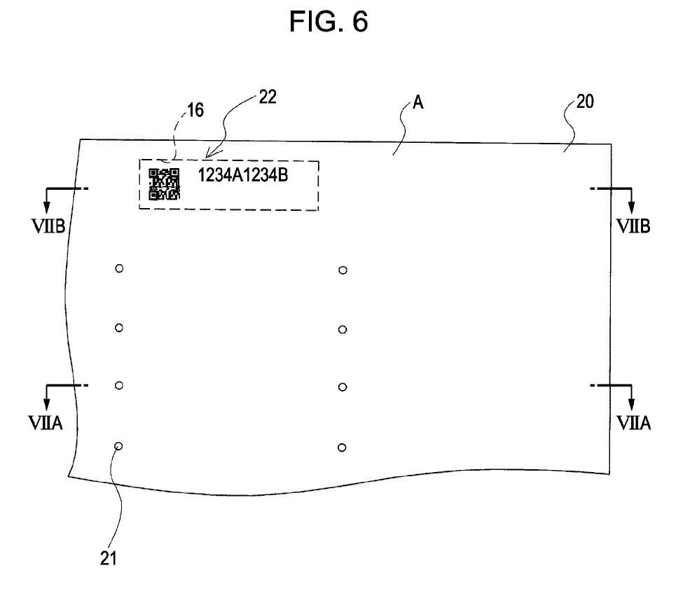

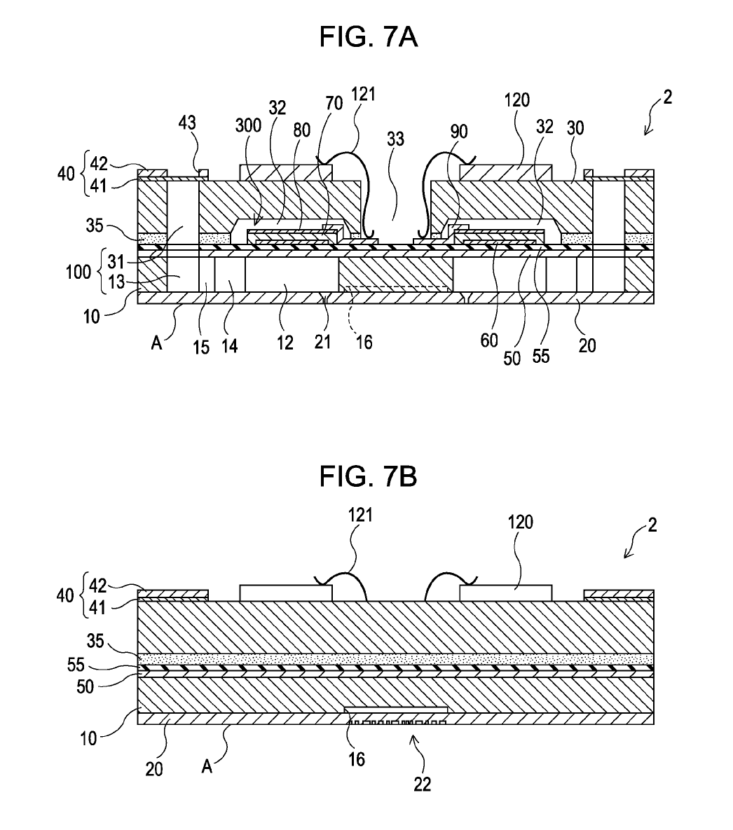

In the following description, the configuration of the ink-jet recording head 2 that is a non-limiting example of various kinds of liquid ejecting heads according to the present embodiment of the invention is explained in detail. FIG. 5 is an exploded perspective view that schematically illustrates an example of the configuration of the ink-jet recording head 2 according to the present embodiment of the invention. FIG. 6 is a plan view that schematically illustrates an example of the liquid-ejecting surface of the ink-jet recording head 2 illustrated in FIG. 5. FIG. 7A is a sectional view taken along the line VIIA-VIIA of FIG. 6, whereas FIG. 7B is a sectional view taken along the line VIIB-VIIB of FIG. 6.

In the present embodiment of the invention, a fluid channel formation substrate 10 (i.e., flow channel formation substrate) that constitutes a part of the ink-jet recording head 2 is made of silicon single crystal. As illustrated in these drawings, an elastic membrane 50, which is made of silicon dioxide, is formed on one surface of the fluid channel formation substrate 10. The elastic membrane 50 has a thickness of 0.5-2.0 μm. Pressure generation chambers (i.e., pressure generation compartments) 12, which are demarcated by a plurality of partition walls 11 from one another, are formed in the fluid channel formation substrate 10. In the example explained herein, two array blocks of the pressure generation chambers 12 are formed in such a manner that the pressure generation chambers 12 of each of these two array blocks are arranged along the width direction (i.e., shorter-side direction) of the fluid channel formation substrate 10, which means that the chamber-array direction (i.e., width direction) of one of these two array blocks is the same as (i.e., parallel with) that of the other thereof. By employing an anisotropic etching technique, the pressure generation chambers 12 are formed from the opposite side of the fluid channel formation substrate 10. In the neighborhood of one end of each of the elongated pressure generation chambers 12 as viewed in the length direction thereof, an ink supply passage 14 and a communication passage 15 are formed. The partition walls 11 also demarcate the ink supply passages 14 and the communication passages 15.

A communicating portion 13 is formed at an area next to one end of each of the communication passages 15. The communicating portion 13 is in communication with a reservoir portion 31 that is provided in the protection substrate 30 that will be described later. In communication with each other, the communicating portion 13 and the reservoir portion 31 constitute a reservoir 100, which serves as a common ink chamber/compartment for each of the pressure generation chambers 12.

Each of the ink supply passages 14 is in communication with the above-described one end (as viewed in the length direction thereof) of the corresponding one of the elongated pressure generation chambers 12. Each of the ink supply passages 14 has a relatively small sectional area, that is, cross section, in comparison with that of the corresponding pressure generation chamber 12. Having a smaller cross section than that of the corresponding pressure generation chamber 12, each of the ink supply passages 14 narrows the width of the corresponding flow channel that provides communication between the reservoir 100 and the corresponding pressure generation chamber 12 at a position next to the above-described one end of the corresponding one of the elongated pressure generation chambers 12 in the non-limiting exemplary configuration of the ink-jet recording head 2 according to the present embodiment of the invention. With such a flow-channel-narrowing structure, each of these ink supply passages 14 keeps the flow-channel resistance of ink that flows from the communicating portion 13 into the corresponding pressure generation chamber 12 at a constant level. In the configuration of the ink-jet recording head 2 according to the present embodiment of the invention, it is explained and illustrated that each of the partition walls 11 has a one-side bulged structure that determines/defines the (sectional) shape of the corresponding one of the ink supply passages 14 to narrow the width of the corresponding (individual) flow channel from/at only one edge thereof. However, the scope of the invention is not limited to such an exemplary configuration. That is, each of the partition walls 11 may have a two-side bulged structure so as to modify the shape of the corresponding one of the ink supply passages 14, thereby narrowing the width of the corresponding flow channel not from/at only one edge thereof but from/at two (i.e., both) edges thereof. As another modification thereof, in place of narrowing the width of the flow channel, the shape of the ink supply passage 14 may be modified so as to reduce the “thickness” of the flow channel. Each of the communication passages 15 is in communication with the corresponding the ink supply passage 14 at one end of the ink supply passage 14 that is opposite to the pressure-generation-chamber-side (12) end thereof. Each of the communication passages 15 has a relatively large sectional area in comparison with that of the corresponding ink supply passage 14 as viewed along the width (i.e., shorter-side) direction thereof. In the configuration of the ink-jet recording head 2 according to the present embodiment of the invention, the communication passage 15 has the same sectional area as that of the pressure generation chamber 12.

To sum up, in the configuration of the fluid channel formation substrate (i.e., flow channel formation substrate) 10 according to the present embodiment of the invention, the plurality of partition walls 11 demarcate the pressure generation chambers (i.e., pressure generation compartments) 12, the ink supply passages 14, and the communication passages 15. Specifically, for each individual flow channel, the ink supply passage 14 that has a relatively small sectional area in comparison with that of the corresponding pressure generation chamber 12 as viewed along the shorter-side direction thereof is demarcated therein. In addition thereto, for each individual flow channel, the communication passage 15 that has a relatively large sectional area in comparison with that of the corresponding ink supply passage 14 as viewed along the shorter-side direction thereof is also demarcated therein so as to be in communication with the corresponding the ink supply passage 14 at one end of the ink supply passage 14 that is opposite to the pressure-generation-chamber-side (12) end thereof.

The nozzle plate 20 is adhered to the opening-surface-side of the fluid channel formation substrate 10 by means of an adhesive, a thermal deposition/welding film, or any other similar alternative means. A plurality of nozzle orifices (i.e., nozzle openings or nozzle holes) 21 is bored through the nozzle plate 20. Each nozzle orifice 21 is communicated with one end, or more exactly, in the proximity thereof, of each of the pressure generation chambers 12 opposite to the other end thereof next to which the ink supply passage 14 is formed. In the configuration of the ink-jet recording head 2 according to the present embodiment of the invention, the surface at which these nozzle holes 21 of the nozzle plate 20 are exposed to the outside constitutes the liquid-ejecting surface A thereof. As a non-limiting material thereof, the nozzle plate 20 is made of glass ceramics, a silicon single crystal substrate, a metal plate such as a stainless-steel plate, or the like.

A head-information-recording portion (i.e., head-information-recording region) 22 that “records” head information is formed in the liquid-ejecting surface A of the nozzle plate 20. The head-information-recording portion 22 can be formed by means of a variety of formation methods that are not restrictively specified herein. For example, a laser beam may be irradiated onto the liquid-ejecting surface A of the nozzle plate 20 so as to form the head-information-recording portion 22. As another example thereof, the liquid-ejecting surface A of the nozzle plate 20 may be subjected to etching so as to form the head-information-recording portion 22. As still another example thereof, the liquid-ejecting surface A of the nozzle plate 20 may be physically worked so as to form the head-information-recording portion 22. The method of the formation of the head-information-recording portion 22 is not limited to these examples. If the liquid-ejecting surface A of the nozzle plate 20 is physically worked, the head-information-recording portion 22 is formed without causing any penetration at the worked region of the nozzle plate 20 in the thickness direction thereof. In this way, the “embossed” head-information-recording portion 22 having concavity and convexity is formed. Even in a case where a liquid-repellent film such as a water-repellent film is formed on the liquid-ejecting surface A of the nozzle plate 20, it is still possible to form the head-information-recording portion 22 by means of a laser beam machining technique.

As a non-limiting specific example thereof, the head-information-recording portion 22 can be formed as a two-dimensional code such as a QR code (registered trademark) or a bar code. As another non-limiting specific example thereof, characters, signs, symbols, and/or any equivalent thereof, may be embossed or formed in other manner in place of, or in addition to, the above-described two-dimensional code so as to embody the head-information-recording portion 22. If such characters, signs, symbols, and/or any equivalent thereof (hereafter collectively referred to as “character information”), are formed in addition to the above-described two-dimensional code as the head-information-recording portion 22, it is still possible to read out head information on the basis of the character information even in a case where it has become impossible to read it out on the basis of the two-dimensional code for any reason, for example, due to the settlement of dust thereon or the formation of scratch therein. By this means, it is possible to avoid or reduce any yield loss, which would occur if the ink-jet recording head 2 were discarded when it has become impossible to read out the head information thereof due to the impaired readability of the two-dimensional code.

The head information that is “embedded” (i.e., recorded) in the head-information-recording portion 22 includes, without any limitation thereto, at least one of the lot number or other number of a wafer out of which the fluid channel formation substrate 10 is cut during the production thereof and the location (such as address) of the fluid channel formation substrate 10 in the uncut wafer. In addition thereto, the head information may further include, without any limitation thereto, measured ink-discharging characteristics (liquid-ejecting characteristics) failure/breakdown history, and maintenance/repair history.

The head information of the head-information-recording portion 22 formed in (herein referred to as “in” without any intention to limit the scope of the invention so as to imply the “emboss carved” or convex/concave pattern thereof) the liquid-ejecting surface A of the nozzle plate 20 can be read out by means of a scanning device that is not illustrated in the drawing. The scanning device, which may be a popular hand-held scanning device such as a barcode reader/scanner or a QR code reader/scanner, though not limited thereto, is held and moved over the head-information-recording portion 22 from the outside of the ink-jet recording head 2 for reading thereof.

The head-information-recording portion 22 is formed in the liquid-ejecting surface A of the nozzle plate 20 at a region that is covered by a holding plate 250, which is a holding member. A more detailed explanation of the holding plate 250 will be given later. In the configuration of each of the ink-jet recording heads 2 according to the present embodiment of the invention, the head-information-recording portion 22 is formed at a region that lies at (i.e., in the neighborhood of) one end of a pair of nozzle arrays made up of the nozzle holes 21 of the nozzle plate 20 among an entire adhesive region to which the holding plate 250 is adhered.

Since the head-information-recording portion 22 is formed in the liquid-ejecting surface A of the nozzle plate 20 as described above, it is possible to read out the aforementioned head information out of the head-information-recording portion 22 in an easy manner. In addition, since the head-information-recording portion 22 is formed at a peripheral region of the ink-jet recording head 2, where the term “peripheral region” means a surrounding region other than the nozzle-hole array region at which the nozzle holes 21 of the nozzle plate 20 are opened, the formation of the head-information-recording portion 22 can be performed with less restriction than otherwise. Specifically, since the head-information-recording portion 22 is formed at a peripheral region of the ink-jet recording head 2, it is possible to record relatively large amount of the head information in the head-information-recording portion 22, including but not limited to, the aforementioned lot number or other number of a wafer out of which the fluid channel formation substrate 10 is cut during the production thereof, the location (such as address) of the fluid channel formation substrate 10 in the uncut wafer, measurement results of ink-discharging characteristics (liquid-ejecting characteristics), failure/breakdown history, and maintenance/repair history. Moreover, since the head-information-recording portion 22 is formed at a peripheral region of the ink-jet recording head 2, it is possible to add an extra head-information-recording portion(s) 22.

Furthermore, since the head information can be directly recorded on the nozzle plate 20 in the form of the head-information-recording portion 22, it is possible to eliminate any need for a database or the like that is related to or associated with the identification numbers of the ink-jet recording heads 2, which would be required if the identification numbers of the ink-jet recording heads 2 only were recorded in the head-information-recording portion 22. With such a configuration, even in a case where it is practically impossible to perform the uniform management of the database and/or to use the same single database at factories or other locations, it is possible to easily look up the head information just by scanning the head-information-recording portion 22 by means of a reading device.

As illustrated in FIGS. 7A and 7B, a concave portion 16 is formed in one surface of the fluid channel formation substrate 10 to which the nozzle plate 20 is adhered. The concave portion 16 is formed at a region that faces the head-information-recording portion 22. The concave portion 16 that is formed opposite to the head-information-recording portion 22 in the nozzle-plate-adhesion surface of the fluid channel formation substrate 10 is configured as a separate concavity that is not in communication with the aforementioned fluid flow channels each of which has the pressure generation chamber 12 and the like.

The concave portion 16 of the ink-jet recording head 2 according to the present embodiment of the invention is formed as a rectangular concavity as observed in a plan view. The sidewall surfaces thereof are formed to be perpendicular to the bottom surface of the rectangular concavity opened in the nozzle-plate-adhesion surface of the fluid channel formation substrate 10. The concave portion 16 can be formed in the fluid channel formation substrate 10 by means of an anisotropic etching technique, though not limited thereto, applied thereto with a high precision so as to have a desired depth. The anisotropic etching performed for the purpose of the formation of the concave portion 16 may not be a separate process that is different from the anisotropic etching performed for the purpose of the formation of the aforementioned fluid flow channels including the pressure generation chambers 12 and the like. That is, the formation of the concave portion 16 and the fluid flow channels including the pressure generation chambers 12 and the like can be advantageously performed concurrently in the same single anisotropic etching process, though not necessarily limited thereto.

It is preferable that the depth of the concave portion 16 should be within a range from 10 μm through 20 μm on the condition that the thickness of the fluid channel formation substrate 10 is approximately 70 μm. With the preferred configuration described above, since the depth of the concave portion 16 is not smaller than 10 μm, it is possible to ensure that the fluid channel formation substrate 10 will not be damaged during the laser formation of the head-information-recording portion 22 in the liquid-ejecting surface A of the nozzle plate 20 because of the deformation of the nozzle plate 20. Specifically, generally speaking, the fluid channel formation substrate 10 and the nozzle plate 20 are heated during the laser formation of the head-information-recording portion 22. As a result thereof, the nozzle plate 20 could become deformed due to a difference between the coefficient of linear expansion of the fluid channel formation substrate 10 and the coefficient of linear expansion of the nozzle plate 20. Such a deformation could cause, generally speaking again, the damaging of the fluid channel formation substrate 10. The above-described preferred configuration having the depth of the concave portion 16 not smaller than 10 μm can reliably prevent the fluid channel formation substrate 10 from being damaged for the reason described above. In addition, further generally speaking, an undesirable gap could be formed between the fluid channel formation substrate 10 and the nozzle plate 20 as a result of the deformation of the nozzle plate 20. If this occurs, there will arise a problem of the possible leakage of ink through the formed clearance therebetween. The above-described preferred configuration having the depth of the concave portion 16 not smaller than 10 μm can reliably prevent such a problem. On the other hand, with the preferred configuration described above, since the depth of the concave portion 16 is not larger than 20 μm, it is possible to ensure that the fluid channel formation substrate 10 will not be damaged during the laser formation of the head-information-recording portion 22 in the liquid-ejecting surface A of the nozzle plate 20 because of the occurrence of any crack therein. Specifically, generally speaking, as a result of the heating of the fluid channel formation substrate 10 and the nozzle plate 20 during the laser formation of the head-information-recording portion 22, the nozzle plate 20 could become deformed due to a difference between the coefficient of linear expansion of the fluid channel formation substrate 10 and the coefficient of linear expansion of the nozzle plate 20. Such a deformation could cause, generally speaking again, a crack or other similar breakage at a vulnerable region that has a relatively weak rigidity or mechanical strength, that is, at the bottom surface of the concave portion 16. The above-described preferred configuration having the depth of the concave portion 16 not larger than 20 μm can reliably prevent the fluid channel formation substrate 10 from being damaged for the reason described above.

In addition, it is further preferable that the area of the concave portion 16 should be larger than that of the head-information-recording portion 22. In other words, it is preferable that the head-information-recording portion 22 should be formed in an area smaller than that of the concave portion 16.

As explained above, in the configuration of the ink-jet recording head 2 according to the present embodiment of the invention, the concave portion 16, which is configured as a separate concavity that is not in communication with the aforementioned fluid flow channels, is formed in one surface of the fluid channel formation substrate 10 to which the nozzle plate 20 is adhered. In addition, the head-information-recording portion 22 is formed in the liquid-ejecting surface A of the nozzle plate 20 at a region that faces the concave portion 16 and has an area smaller than that of the concave portion 16. With such a configuration, it is possible to prevent the fluid channel formation substrate 10 from being damaged at the time when the nozzle plate 20 becomes deformed due to a difference between the coefficient of linear expansion of the fluid channel formation substrate 10 and the coefficient of linear expansion of the nozzle plate 20 as a result of the heating of the fluid channel formation substrate 10 and the nozzle plate 20 during the laser formation of the head-information-recording portion 22. Moreover, in the configuration of the ink-jet recording head 2 according to the present embodiment of the invention, it is further possible to prevent the formation of any gap between the fluid channel formation substrate 10 and the nozzle plate 20 and resultant problems otherwise arising therefrom. Since the concave portion 16 is configured as a separate concavity that is not in communication with the aforementioned pressure generation chambers 12 and the like that make up the aforementioned fluid flow channels, even in a case where any foreign object is undesirably formed in the concavity 16 as a result of the deformation of the nozzle plate 20 due to the difference between the coefficient of linear expansion of the fluid channel formation substrate 10 and that of the nozzle plate 20, it is possible to ensure that the formed foreign object never flows into any of the fluid flow channels, thereby preventing the resultant clogging of any of the nozzle holes 21 or other similar problem from occurring.

As has already been mentioned above, the elastic membrane 50 having a thickness of, for example, approximately 1.0 μm is formed on the other surface of the fluid channel formation substrate 10 that is opposite to the opening surface thereof. An insulating film 55 having a thickness of, for example, approximately 0.4 μm is deposited on the elastic membrane 50. The insulating film 55 is made of, for example, zirconium oxide (ZrO₂) or the like. A lower electrode film 60, a piezoelectric substance layer 70, and an upper electrode film 80 are provided on the insulating film 55 so as to form piezoelectric elements 300. More specifically, each of the piezoelectric elements 300 is made up of the lower electrode film 60 having a thickness of, for example, approximately 0.1-0.5 μm, the piezoelectric substance layer 70 having a thickness of, for example, approximately 1.1 μm, and the upper electrode film 80 having a thickness of, for example, approximately 0.05 μm. The piezoelectric substance layer 70 is made of a piezoelectric material such as lead zirconate titanate (PZT) or the like. The lower electrode film 60, the piezoelectric substance layer 70, and the upper electrode film 80 are laminated in the order of appearance herein by means of a film deposition method and a lithography method. The lamination of the lower electrode film 60, the piezoelectric substance layer 70, and the upper electrode film 80 constitutes the piezoelectric element 300. Generally speaking, either one of the lower electrode film 60 and the upper electrode film 80 of the piezoelectric elements 300 is configured as a common electrode, whereas the other thereof as well as the piezoelectric substance layer 70 are individually patterned for each of the pressure generation chambers 12. In this specification, a region of layers that is constituted by the piezoelectric substance layer 70 and either one of the lower electrode film 60 and the upper electrode film 80, which are individually patterned for each of the pressure generation chambers 12, is referred to as a “piezoelectric substance activation portion” 320, where the piezoelectric substance activation portion 320 indicates a region of layers at which piezoelectric distortion/deflection occurs at the time of application of a voltage to both electrodes. In the present exemplary embodiment of the invention, the lower electrode film 60 is configured as the common electrode of the piezoelectric elements 300, whereas the upper electrode films 80 are configured as the individual electrodes thereof. Notwithstanding the foregoing, the lower electrode film 60 and the upper electrode film 80 may be reversed if it is required or advantageous because of the circuit line patterning, driving circuit layout, and/or any other similar reasons. Whichever configuration is chosen, one piezoelectric substance activation portion is formed for each of the pressure generation chambers 12. In addition, in this specification, the piezoelectric elements 300 and a vibrating plate (i.e., diaphragm) that is displaced when driven by the piezoelectric elements 300 are correctively referred to as an actuator device. In the exemplary configuration described above, the insulating film 55 and the lower electrode film 60 function as the vibrating plate. However, the invention is not limited to such an exemplary configuration but may be modified, for example, in such a manner that the lower electrode film 60 only functions as the vibrating plate while omitting the insulating film 55 from the configuration. As another non-limiting modification example thereof, the piezoelectric elements 300 may substantially double as, that is, also function as, the vibrating plate without providing any separate one.

A lead electrode 90, which is made of gold (Au) or the like, is connected to each of the upper electrode films 80, which constitutes an individual electrode of the piezoelectric elements 300. The lead electrode 90 is formed as a wiring that extends from the proximity of one end of the upper electrode film 80 that is opposite to the other end thereof that is closer to the ink supply passage 14. The lead electrode 90 is electrically connected to a driving circuit 120 by means of a connection wiring 121 at a through hole 33. A more detailed explanation thereof will be given later.

The protection substrate 30 is bonded to the fluid channel formation substrate 10 that has the piezoelectric elements 300 formed thereon. The protection substrate 30 has the aforementioned reservoir portion 31 at a region opposite to the aforementioned communicating portion 13. The reservoir portion 31 of the protection substrate 30 is in communication with the communication portion 13 of the fluid channel formation substrate 10. As has already been described above, the reservoir portion 31 and the communication portion 13 make up the aforementioned reservoir 100, which constitutes a common fluid chamber/compartment (e.g., common ink chamber/compartment) for the pressure generation chambers 12. As an example of alternative configurations, the communicating portion 13 of the fluid channel formation substrate 10 may be divided into a plurality of demarcated portions thereof so as to correspond to the respective pressure generation chambers 12. In such a configuration, the reservoir portion 31 only constitutes the reservoir 100. As another example of alternative configurations, it may be configured that the pressure generation chambers 12 only are provided in the fluid channel formation substrate 10, and that the ink supply passages 14 each of which makes the reservoir 100 in communication with the corresponding one of the pressure generation chambers 12 (i.e., the ink supply passages 14 each of which provides a communication between the reservoir 100 and the corresponding one of the pressure generation chambers 12) are formed in a member that is interposed between the fluid channel formation substrate 10 and the protection substrate 30. As a few examples of such a member that is interposed between the fluid channel formation substrate 10 and the protection substrate 30, the ink supply passages 14 may be formed in the elastic membrane 50, the insulating film 55, or the like.

A piezoelectric-element holding portion 32 is provided in the protection substrate 30 at an area opposed to the piezoelectric elements 300. The piezoelectric-element holding portion 32 is provided while leaving an inner space that is wide enough so as not to obstruct the motion of the piezoelectric elements 300. As long as the space is sufficiently large so as not to hamper the movement of the piezoelectric elements 300, it may be sealed or not sealed.

In the present exemplary embodiment of the invention, the aforementioned through hole 33, which penetrates through the protection substrate 30 in its thickness direction, is provided between the piezoelectric-element holding portion 32 of the protection substrate 30 and the reservoir portion 31 thereof. A part of the lower electrode film 60 and the tips of the lead electrodes 90 are exposed inside the through hole 33.

The aforementioned driving circuit 120, which drives the piezoelectric elements 300, is mounted on the protection substrate 30. For example, a circuit board and semiconductor integrated circuits (IC) may constitute the driving circuit 120. The driving circuit 120 is electrically connected to the lead electrodes 90 via the aforementioned connection wiring 121 that is made up of conductive wires such as bonding wires or the like.

It is preferable that the protection substrate 30 should be made of a material having substantially the same coefficient of thermal expansion as that of the fluid channel formation substrate 10 such as glass, ceramic material, or the like. In the present exemplary embodiment of the invention, the protection substrate 30 is made of a silicon single crystal substrate having a surface orientation of (110), that is, the same material that constitutes the fluid channel formation substrate 10.

A compliance substrate 40, which is made up of a sealing film 41 and a fixation plate 42, is adhered to the protection substrate 30. The sealing film 41 is made of a flexible material having a low rigidity (for example, a polyphenylene sulfide (PPS) film having a thickness of 6 μm). The sealing film 41 seals one end of the reservoir portion 31. On the other hand, the fixation plate 42 is made of a hard material such as metal (for example, a stainless steel (SUS) having a thickness of 30 μm). Some region of the fixation plate 42 that is opposed to the reservoir 100 constitutes an opening 43, that is, an open space that penetrates through the fixation plate 42 in its thickness direction. As the fixation plate 42 has such a structure, it is the flexible sealing film 41 only that seals one end of the reservoir 100.

As illustrated in FIG. 4, the aforementioned head case 230 is provided on the other surface that is opposite to the liquid-ejecting surface A of each of the ink-jet recording heads 2. Ink coming from the ink cartridges 1A and 1B is supplied to ink-feed holes 44 via ink-communicating passages 212 of the cartridge case 210 and ink-supply communicating holes (i.e., ink-supply communicating passages) formed in the head case 230. The ink-supply communicating holes are not illustrated in the drawing.

The ink-jet recording head 2 according to the present embodiment of the invention having the configuration described above operates as follows. First of all, ink retained in an ink cartridge 1A, 1B flows through the ink feed hole 44 after having passed through the ink communicating passage 212 and the ink supply communicating passage (which is not shown in the drawing). The inner fluid channel structure from the reservoir 100 to the nozzle orifices 21 is filled with the supplied ink. Thereafter, in accordance with a recording signal sent from the driving circuit 120, a voltage is applied to the piezoelectric element 300 that corresponds to each of the pressure generation chambers 12 so as to deflect and deform the elastic membrane 50 and the piezoelectric element 300. By this means, the inner pressure of each of the pressure generation chambers 12 is raised; and as a result thereof, ink drops are discharged from the nozzle orifice 21.

The ink-jet recording heads 2 described above are manufactured as follows. First of all, a large number of chips are formed at the same time on a single piece of silicon wafer. Then, the nozzle plate 20 and the compliance substrate 40 are bonded thereto so as to form a single integrated in-process product. Subsequently, the single integrated in-process wafer is diced into a number of the fluid channel formation substrates 10 illustrated in FIG. 5, each having one chip size thereof. This is how the ink-jet recording heads 2 described above are manufactured. Then, after the production of the ink-jet recording head 2 having an exemplary configuration illustrated in FIG. 5, the liquid-ejecting surface A of the ink-jet recording head 2 is subjected to laser machining. In this way, the head-information-recording portion 22 that has head information recorded in the form of a convex and concave pattern can be formed in the liquid-ejecting surface A thereof. Needless to say, in place of the “after-production” formation of the head-information-recording portion 22 that has head information recorded in the form of a convex and concave pattern in the liquid-ejecting surface A of the final-product ink-jet recording head 2 by laser-machining the liquid-ejecting surface A thereof after the production of the ink-jet recording head 2 having an exemplary configuration illustrated in FIG. 5, the head-information-recording portion 22 may be formed in a certain manufacturing step performed during the production of the ink-jet recording head 2.

Four ink-jet recording heads 2 described above are bonded to the bottom surface of the cartridge case 210 by means of an adhesive. In the configuration of the ink-jet recording apparatus I according to the present embodiment of the invention, these four ink-jet recording heads 2 are fixed onto the cartridge case 210 with a certain predetermined space allocated each therebetween in such a manner that they are arranged in a direction in which nozzle lines 21A thereof are arranged. That is, eight lines, in total, of the nozzle lines 21A are provided in the ink-jet recording apparatus I according to the present embodiment of the invention. As described above, by increasing the number of a pair of the nozzle lines 21A, which is made up of the nozzle openings 21 arrayed as parallel two lines on the ink-jet recording head 2, by means of not a singularity but a plurality of the ink-jet recording heads 2, it is possible to ensure a relatively high production yield rate in comparison with a case where an increased number (i.e., in this context, more than two) of the nozzle lines 21A are formed on just one ink-jet recording head 2. In addition thereto, the employment/adoption/use of a plurality of the ink-jet recording heads 2 for the purpose of increasing the number of the nozzle lines 21A makes it possible to also increase the number of chips, each of which is used as a material for the ink-jet recording head 2, that can be diced out of a single piece of silicon wafer. Therefore, it is further possible to decrease the wasted area of the silicon wafer, thereby efficiently reducing the production cost thereof.

The holding plate 250 supports these four ink-jet recording heads 2 with positions thereof being determined in a fixed manner thereby as illustrated in FIGS. 2 and 4. The holding plate 250, which is a common fixation member, is adhered to the liquid-ejecting surfaces A of these ink-jet recording heads 2. The holding plate 250 functions as a common member to support these ink-jet recording heads 2. The holding plate 250 has an exposure-opening portion 251 and a bonding portion 252. The exposure-opening (i.e., window) portion 251 of the holding plate 250 exposes the nozzle openings 21. The bonding portion 252 thereof, which demarcates the exposure-opening portion 251 thereof, are bonded to at least both side (end) portions of the nozzle lines 21A of the liquid-ejecting surfaces A of these ink-jet recording heads 2.

In the configuration of the ink-jet recording apparatus I according to the present embodiment of the invention, the bonding portion 252 of the holding plate 250 is made up of a fixation frame portion 253 and fixation beam portions 254. The fixation frame portion 253 of the bonding portion 252 is a peripheral frame that encloses the liquid-ejecting surfaces A of these ink-jet recording heads 2. Each of the fixation beam portions 254 thereof extends between two of the ink-jet recording heads 2 adjacent to each other in such a manner that these fixation beam portions 254 divide/split the exposure-opening portion 251. The bonding portion 252 of the holding plate 250, which is constituted by the fixation frame portion 253 and the fixation beam portions 254, is bonded to the liquid-ejecting surfaces A of these ink-jet recording heads 2. Since the plurality of ink-jet recording heads 2 are adhered to the holding plate 250, which is a common fixation member, it is possible to make the level of the liquid-ejecting surfaces A of these ink-jet recording heads 2 equal to one another. As a result thereof, it is possible to make the landing positions of liquid (e.g., ink) on the recording sheet S uniform, thereby offering high-precision printing.

When assembling the plurality of ink-jet recording heads 2 together so as to make up the head unit 1 according to the present embodiment of the invention, it is possible to read the head information out of the head-information-recording portion 22 by means of a scanning device to choose an optimum set of the ink-jet recording heads 2 having the same liquid-ejecting characteristics (e.g., ink-discharging characteristics). That is, even though the ink-discharging characteristics of the ink-jet recording heads 2 could vary from one to another depending on the lot number or other number of a wafer out of which the fluid channel formation substrate 10 is cut during the production thereof and the location (such as address) of the fluid channel formation substrate 10 in the uncut wafer, it is possible to read the head information out of the head-information-recording portion 22 by means of a scanning device to choose an optimum set of the ink-jet recording heads 2 whose fluid channel formation substrate 10 are cut out of the same single wafer or cut at the same address thereof, thereby making it further possible to ensure uniform ink-discharging characteristics among the ink-jet recording heads 2 that are assembled together to make up the head unit 1.

As has already been described above, in the configuration of each of the ink-jet recording heads 2 according to the present embodiment of the invention, the head-information-recording portion 22 is formed in the liquid-ejecting surface A of the nozzle plate 20 at a region to which the holding plate 250 is adhered, or more specifically, a region to which the bonding portion 252 of the holding plate 250 is adhered. Accordingly, in the configuration of the head unit 1 according to the present embodiment of the invention, the head-information-recording portion 22 that is formed in the liquid-ejecting surface A is covered by the holding plate 250. Since the holding plate 250 covers the head-information-recording portion 22, it is possible to prevent the aforementioned wiping unit 9 from becoming in contact with the head-information-recording portion 22 during its operation so as to be damaged by the head-information-recording portion 22. Therefore, it is possible to prevent the cleaning capability of the wiping unit 9 from becoming lowered. In addition thereto, since the holding plate 250 covers the head-information-recording portion 22, it is possible to unfailingly prevent ink from remaining on the head-information-recording portion 22 without being wiped therefrom even after the cleaning of the liquid-ejecting surface A performed by means of the wiping unit 9, thereby making it further possible to unfailingly prevent any dropping of such remaining ink onto a recording sheet S. Moreover, since the holding plate 250 covers the head-information-recording portion 22, it is possible to unfailingly prevent ink that remains on the head-information-recording portion 22 without being wiped therefrom even after the cleaning of the liquid-ejecting surface A performed by means of the wiping unit 9 from becoming thickened thereon, thereby making it further possible to unfailingly prevent such thickened ink from adhering to the nozzle holes 21 at the time of the execution of wiping so as to cause the clogging thereof and/or the degradation of liquid discharging characteristics thereof.

Moreover, in the configuration of the head unit 1 according to the present embodiment of the invention, it is possible to manufacture the nozzle plate 20 by using a single sheet of plate material member. Therefore, in comparison with a case where the nozzle plate 20 is manufactured not from a single sheet of plate material member but from plural sheets of plate material member, it is possible to achieve a relatively short distance from the pressure generation chamber 12 to the open end of the nozzle hole 21 in the liquid-ejecting surface A, thereby making it further possible to obtain excellent liquid-ejecting characteristics. Furthermore, in the configuration of the head unit 1 according to the present embodiment of the invention, since it is possible to manufacture the nozzle plate 20 by using a single sheet of plate material member, in comparison with a case where the nozzle plate 20 is manufactured from plural sheets of plate material member, it is possible not only to form the head-information-recording portion 22 in the liquid-ejecting surface A of the nozzle plate 20 in an easier manner but also to avoid any decrease in the rigidity of component members that make up the nozzle plate 20, thereby making the handling of the nozzle plate 20 easier.

As illustrated in FIGS. 2 and 3, the ink-jet recording head unit 1 is further provided with a cover head 240, which has a box-like shape so as to cover the ink-jet recording heads 2. The cover head 240 is provided at one face of the holding plate 250 opposite the other face thereof that is adhered to the ink-jet recording heads 2. The cover head 240 has a fixation portion 242 and sidewall portions 245. The fixation portion 242 thereof demarcates an opening (window) portion 241 that corresponds to the exposure-opening portion 251 of the holding plate 250. The sidewall portions 245 thereof are formed by bending a cover head material in such a manner that each side thereof extends toward the side surface with respect to the ink-drop-discharging surface of the ink-jet recording head 2 so as to cover the periphery of the holding plate 250.

In the configuration of the head unit 1 according to the present embodiment of the invention, the fixation portion 242 of the cover head 240 is made up of a frame portion 243 and beam portions 244. The frame portion 243 corresponds to the fixation frame portion 253 of the holding plate 250, whereas the beam portions 244 corresponds to the fixation beam portions 254 thereof. The fixation portion 242 of the cover head 240, which is made up of the frame portion 243 and the beam portions 244 as described above, is bonded to the bonding portion 252 of the holding plate 250.

As explained above, since the liquid-ejecting surface A of the ink-jet recording head 2 is bonded to the cover head 240 with no gap left therebetween, it is possible to prevent a recording target medium (such as paper) from entering therebetween. Thus, the deformation of the cover member 240 and paper jam malfunction do not occur. In addition thereto, it is possible to prevent the infiltration of ink over/into the side surfaces of the ink-jet recording heads 2 without failure because the sidewall portions 245 of the cover head 240 completely cover the outer edges of the ink-jet recording heads 2.

As illustrated in FIGS. 2 and 4, supporting portions 246 are provided on the fixation portion 242. Each of the supporting portions 246 has a fixation hole 247, which is used for determining the position of the cover head 240 with respect to the cartridge case 210. A cover head material is bent from the sidewall portion 245 in a surface direction parallel to the ink-drop discharge surface so as to form each of the supporting portions 246. In the configuration of the head unit 1 according to the present embodiment of the invention, the cover head 240 is fixed to the cartridge case 210. Specifically, the cartridge case 210 is provided with projections 215 each of which protrudes toward the liquid-ejecting surface A. The projections 215 are configured such that they can be inserted through the respective fixation holes 247 of the cover head 240. The cover head 240 is fixed to the cartridge case 210 by inserting the projections 215 through the respective fixation holes 247 of the cover head 240, and then by heat-caulking or heat-crimping the tip of each of the projections 215.

In the foregoing exemplary embodiment of the invention, it is assumed that the cover head 240 is adhered to one face of the holding plate 250 opposite the other face thereof that is adhered to the ink-jet recording heads 2. However, the scope of the invention is not limited to such an exemplary configuration. That is, the cover head 240 may not be adhered to the holding plate 250. As a non-limiting modification example thereof, the cover head 240 may be provided without being adhered to the holding plate 250 so as to have a certain gap therebetween. As another non-limiting modification example thereof, the cover head 240 may be provided in contact with the holding plate 250 without being adhered thereto.

### Other Embodiments

Although the first exemplary embodiment of the invention is explained above, needless to say, the basic configuration and the scope of the invention is in no case limited to any of the above specific embodiments/examples. Although the holding plate 250 is taken as an example of a holding member (i.e., fixation member) that is adhered to the liquid-ejecting surface A of the ink-jet recording head 2 in the first exemplary embodiment of the invention described above, the scope of the invention is not limited to such an exemplary configuration. For example, the cover head 240 may be directly adhered to the liquid-ejecting surface A of the ink-jet recording head 2 without interposing the holding plate 250 therebetween. In other words, the cover head 240 may be used as the fixation member.

In the configuration of the ink-jet recording apparatus I according to the first exemplary embodiment of the invention described above, it is explained that one ink-jet recording head unit 1 has four ink-jet recording heads 2. However, the number of the ink-jet recording heads 2 is not limited to the specific example explained above. In addition, the arrangement/array of the ink-jet recording heads 2 is also not limited to the specific example explained above. The invention is applicable as long as one ink-jet recording head unit 1 has at least one ink-jet recording head 2. In a case where one ink-jet recording head unit 1 has more than one ink-jet recording head 2, the plurality of ink-jet recording heads 2 may be arranged/arrayed in a direction in which the nozzle lines 21A thereof are arranged/arrayed or in a direction in which the nozzle holes 21 thereof are arranged/arrayed. The invention is applicable to either case as long as the head-information-recording portion 22 is formed at a region that is covered by the holding plate 250, which is a holding/fixation member.

In the configuration of the ink-jet recording apparatus I according to the first exemplary embodiment of the invention described above, it is explained that the concave portion 16 is formed in the fluid channel formation substrate 10. However, the scope of the invention is not limited to such an exemplary configuration. That is, the concave portion 16 may not be formed in the fluid channel formation substrate 10. Moreover, although it is explained in the foregoing exemplary embodiment of the invention that the head-information-recording portion 22 is formed by means of a laser-machining technique/method, the scope of the invention is not limited to such an exemplary configuration. For example, the head-information-recording portion 22 may be formed by means of other alternative techniques/methods including but not limited to etching, physical working (including “grinding” but not limited thereto), or scratching/scribing that is performed with the use of a scratch gauge or a scriber.

Although it is not specifically explained in the first embodiment of the invention, it is preferable that, in a case where a liquid-repellent film such as a water-repellent film is formed on the liquid-ejecting surface A of the nozzle plate 20, the liquid-repellent film should be partially removed at a region to which the holding plate 250 is adhered so as to form a partial non-repellent region. Hereafter, the term “non-repellent” region is used to refer to a region that repels liquid such as ink. That is, it is preferable that the liquid-repellent film should be formed only at a partial region that is exposed due to the presence of the exposure-opening portion 251 of the holding plate 250 so as to constitute a partial liquid-repellent region. With such a preferred configuration, it is possible to increase a bonding strength between the liquid-ejecting surface A and the holding plate 250. As another non-limiting preferred configuration example, when adhering the aforementioned fixation member such as the holding plate 250 or the cover head 240 to the non-repellent region of the nozzle plate 20, the adhesion may be performed in such a manner that the adhered fixation member partially overlaps, that is, at least slightly overlaps, the liquid-repellent region of the nozzle plate 20. The reason why it is preferable that the adhered fixation member should partially overlap, that is, at least slightly overlap, the liquid-repellent region of the nozzle plate 20 is that, with such a preferred configuration, it is possible to prevent any part of the non-repellent region 26 of the nozzle plate 20 from becoming exposed through the exposure-opening portion 251 of the holding plate 250 due to the possible displacement in the position of the fixation member relative to that of the nozzle plate 20 or vice versa that could occur when the fixation member is adhered to the nozzle plate 20. It should be noted that the region at which the head-information-recording portion 22 is formed constitutes the non-repellent region because the head-information-recording portion 22 is formed at the bonding region of the liquid-ejecting surface A to which the holding plate 250 is to be adhered. Generally speaking, in a case where the head-information-recording portion 22 is formed by means of the laser-machining technique/method, the formation thereof can be performed without any problem regardless of the presence/absence of the liquid-repellent film, whereas, in a case where the head-information-recording portion 22 is formed by means of any technique/method other than the laser-machining technique/method, the formation thereof will be affected depending on the presence/absence of the liquid-repellent film. Nevertheless, because the head-information-recording portion 22 is formed at the non-repellent region, it is possible to form the head-information-recording portion 22 thereat easily even in a case where the head-information-recording portion 22 is formed by means of any non-laser-machining technique/method.

In the configuration of the ink-jet recording apparatus I according to the first exemplary embodiment of the invention described above, it is explained that characters, signs, symbols, and/or any equivalent thereof (i.e., character information), as well as a two-dimensional code are recorded as the head-information-recording portion 22. Notwithstanding the foregoing, needless to say, either one of the character information and the two-dimensional code may be recorded as the head-information-recording portion 22 in place of recording both thereof as the head-information-recording portion 22.

In the configuration of the ink-jet recording apparatus I according to the first exemplary embodiment of the invention described above, it is explained that a thin-film actuator device that includes but not limited to the thin-film piezoelectric element 300 is taken as an example of pressure generating means that causes a pressure change in the pressure generation chamber 12. However, the scope of the invention is not limited to such an exemplary configuration. As a non-limiting modification example thereof, a thick-film actuator device, which is formed by adhering a green sheet(s) thereto or by any other alternative method, may be adopted as the pressure generating means. As another non-limiting modification example thereof, a longitudinal-vibration actuator device, which is formed by laminating a piezoelectric material and an electrode formation material in an alternating order so that it can expand/contract in an axial direction, may be adopted as the pressure generating means. As still another non-limiting modification example thereof, the pressure generating means may be embodied as a thermal-discharging actuator device. Specifically, in such a modified configuration, a heating element/device or the like that is provided in the pressure generation chamber 12 generates heat. The thermal-discharging actuator device discharges liquid drops (e.g., ink drops) from its nozzle holes by utilizing bubbles formed as a result of heat generation. As still another non-limiting modification example thereof, the pressure generating means may be embodied as a so-called electrostatic actuator device. Specifically, in such a modified configuration, static electricity is generated between a vibrating plate and electrodes. Then, electrostatic force is utilized to deflect the vibrating plate so as to discharge liquid drops from nozzle holes.

In the exemplary embodiments of the invention described above, as a typical example of a liquid ejecting head, the invention is explained while exemplifying an ink-jet recording head unit 1 that has a plurality of ink-jet recording heads 2, where the ink-jet recording heads 2 discharge ink as an example of a variety of liquid. Notwithstanding the foregoing, the invention is directed to various kinds of liquid ejecting heads; and therefore, needless to say, the invention is also applicable to a variety of liquid ejecting head unit that has a plurality of liquid ejecting heads. Liquid ejecting heads to which the invention is applicable encompass a wide variety of heads; specifically, they include without any limitation thereto: a recording head that is used in an image recording apparatus such as a printer or the like, a color material ejection head that is used in the production of color filters for a liquid crystal display device or the like, an electrode material (i.e., conductive paste) ejection head that is used for electrode formation for an organic EL display device or a surface/plane emission display device (FED, field emission display) and the like, a living organic material ejection head that is used for production of biochips.

What is claimed is:

1. A liquid ejecting head unit comprising:
a liquid ejecting head that has pressure generation chambers and pressure generators, the pressure generation chambers being in communication with nozzle openings from which liquid is ejected, the pressure generator causing a pressure change in the pressure generation chamber;
a fixing member that is adhered to the liquid ejecting surface of the liquid ejecting head, the liquid ejecting surface having the nozzle openings formed therein, the fixing member having an exposure opening portion that exposes the nozzle openings; and
a recording portion that has convexity and concavity so as to record head information, the recording portion being provided at a region of the liquid ejecting surface at which the fixing member is adhered.

2. The liquid ejecting head unit according to claim 1, wherein a liquid-repellent film is formed on the liquid ejecting surface; and the region of the liquid ejecting surface at which the fixing member is adhered is a non-liquid-repellent region at which the liquid-repellent film is not formed.

3. The liquid ejecting head unit according to claim 1, wherein the liquid ejecting head further has a fluid channel formation substrate in which the pressure generation chambers are formed and a nozzle plate through which the nozzle openings are formed; and the fluid channel formation substrate has a concave portion at a region that faces the recording portion.

4. The liquid ejecting head unit according to claim 1, wherein a plurality of liquid ejecting heads is adhered to the fixing member.

5. The liquid ejecting head unit according to claim 1, wherein a cover head is provided at one-face side of the fixing member opposite the other-face side thereof, the other face of the fixing member being adhered to the liquid ejecting surface of the liquid ejecting head; and the cover head covers the liquid ejecting surface of the liquid ejecting head.

6. The liquid ejecting head unit according to claim 5, wherein the cover head is adhered to the above-mentioned one face of the fixing member opposite the above-mentioned other face thereof that is adhered to the liquid ejecting surface of the liquid ejecting head.

7. A liquid ejecting apparatus that is provided with the liquid ejecting head unit according to claim 1.
